(19) United States
(12) Patent Application Publication
(10) Pub. No.: US 2017/0295756 A1
(43) Pub. Date: Oct. 19, 2017

(54) PREDATOR PROOF MOVABLE POULTRY COOP

(71) Applicant: Andrew RYNNE, Prosperous (IE)

(72) Inventor: Andrew RYNNE, Prosperous (IE)

(21) Appl. No.: 15/099,850

(22) Filed: Apr. 15, 2016

(51) Int. Cl. A01K 31/18; A01K 1/00; A01K 31/10; A01K 31/12

(52) U.S. Cl. CPC A01K 31/18; A01K 31/12; A01K 1/0035; A01K 31/10

(57) ABSTRACT

A predator proof movable coop has an outdoor caged over section, an adjoining roofed-in section with an adjoining nesting box section and one or more retractable wheels. The coop is especially designed to protect the poultry or hens from predators like fox or raccoon or the like.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to the field of poultry coops. The invention, particularly relates to a poultry coop that prevents entry of predators inside and protects from transmission of pathogens to and between the housed birds.

### 2. Description of Related Art Including Information Disclosed Under 37 CFR 1.97 and 37 CFR 1.98

People have been raising poultry for thousands of years. Poultry are raised for eggs, for meat, for educational or research purposes, for show, for enjoyment as pets or some combination. Poultry coops are used to house chickens and other poultry and typically include a house and a run area that is uncovered. As a result, the housed birds are susceptible to the transmission of pathogens or disease from wild bird transmitted from direct contact with the wild birds or from the feces of wild birds dropping into the run area of the coop. Poultry also need housing to nest, lay eggs, and to roost. In addition, food and water can be provided for poultry in housing. In addition to disease, the housed birds are susceptible to predators in conventional coops.

Many cage or coop structures have been devised for housing poultry. The emphasis in the prior art has been on devising housing structures for use in raising large quantities of poultry. Furthermore, many such housing structures for poultry are intended for use inside another larger structure, such as a barn or building, rather than as a stand-alone outdoor structure. But these outdoor structures are vulnerable to predators such as a fox, a raccoon or the like as these do not provide any cover underneath the whole structure at ground level and the predators like fox or raccoon can come inside the coop by digging the ground. Also, there are some poultry coops with wheels which can be moved by two or more persons to remove the rubble and keep the coop clean.

Prior art, U.S. Pat. No. 8,230,817 to Cheryl discloses an improved poultry coop that facilitates the prevention of entry of predators and the transmission of pathogens to and between the housed birds. The coop, which advantageously meets bird flu guidelines, includes an insulated house, a covered run coupled to the house, and a covered feed house. All openings are preferably covered with ½ inch hardware cloth or mesh wire. The same cloth or mesh wire is preferably buried beneath the earth below the coop and coupled to the coop.

Another prior art, U.S. Pat. No. 8,132,536 to Steven discloses a portable and collapsible housing for poultry or other animals that includes a shelter having a half-lap shape, a base cage having a complimentary half-lap shape, a means for joining the shelter onto the base cage to form the housing.

A need therefore exists for a new and improved portable housing structure for raising poultry that provides protection against all kinds of predators and pathogens.

### BRIEF SUMMARY OF THE INVENTION

In the view of the foregoing disadvantages inherent in the known types of poultry coops now present in the prior art, the present invention provides an improved poultry coop. As such, the general purpose of the present invention, which will be described subsequently in greater detail, is to provide a new and improved poultry coop which has all the advantages of the prior art and none of the disadvantages.

An object of the invention is to provide a predator proof movable poultry coop that provides protection to poultry or hens in a predator infested environment.

It is another object of the present invention to provide a movable poultry coop that can be pulled or dragged by a single person.

It is another object of the present invention to provide poultry coop with a roofed-in section with an adjoining nesting box section made from gauged plastic sheeting or marine ply.

It is another object of the present invention to provide a poultry with outer caged over section made from steel mesh mounted on a wooden frame.

It is another object of the present invention to provide wheels attached to the rear portion of the roofed-in section.

It is another object of the present invention to provide poultry coop whose wheels work based on levered wheel mechanism.

It is another object of the present invention to provide poultry coop with a feeder and one or more perches for poultry or hens to stand on at night.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 shows the perspective view of the predator proof movable poultry coop.

FIG. 2 shows the side view of the predator proof movable poultry coop.

FIG. 3 shows the front view of lever wheel mechanism.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

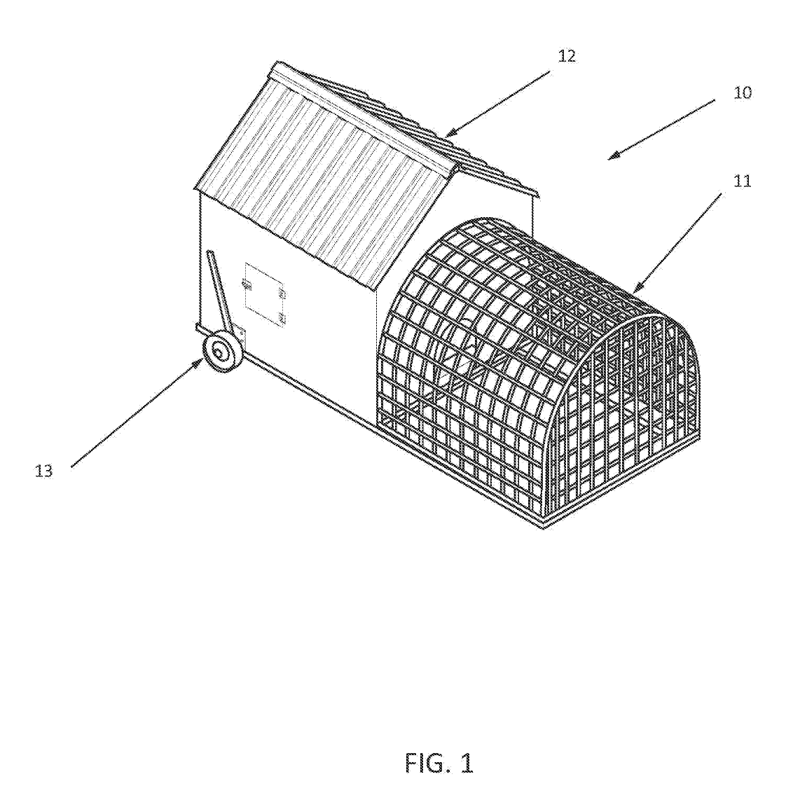

On referring FIG. 1 shows the preferred embodiment of the present invention. The figure shows a poultry coop 10 having an outdoor caged over section 11, an adjoining roofed-in section 12 and a pair of retractable wheels 13.

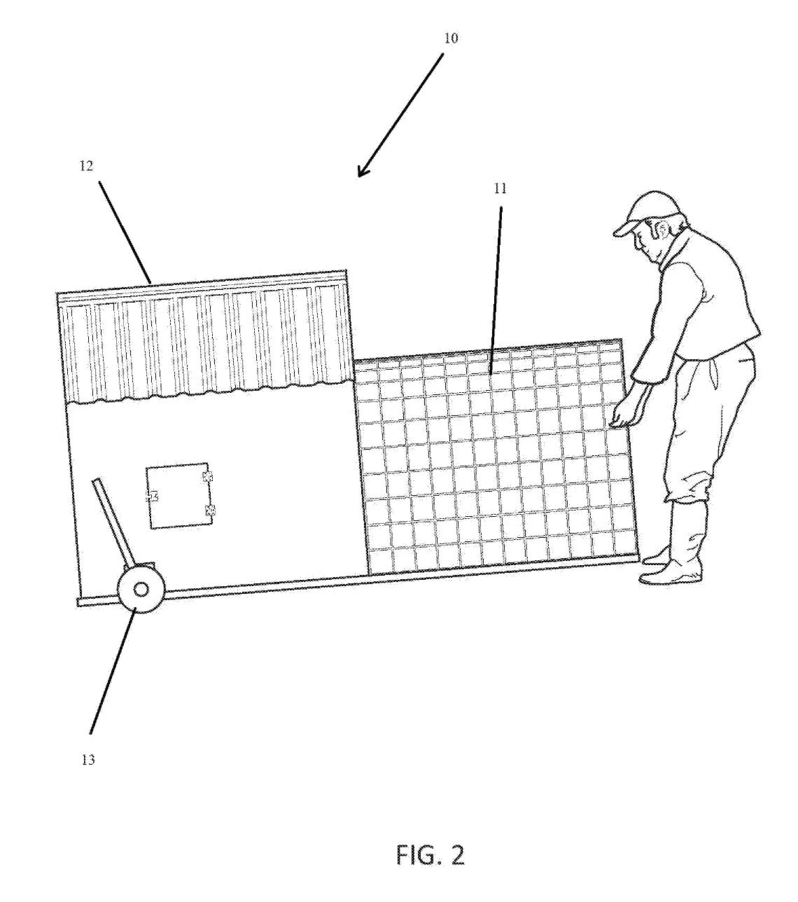

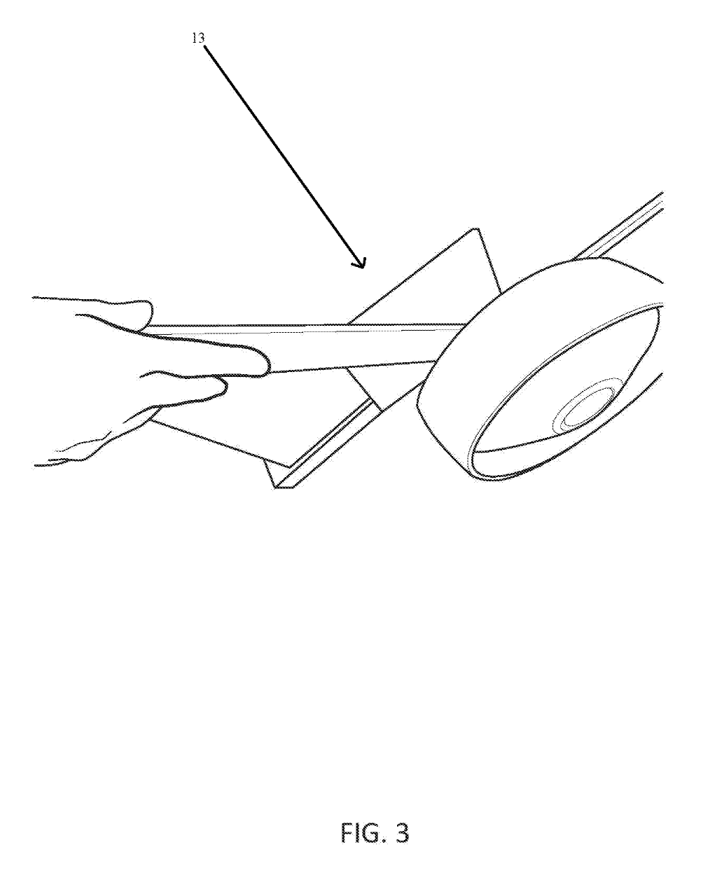

FIG. 2 shows the poultry coop being pulled easily by single person. The coop is designed to accommodate 6-9 hens inside. FIG. 3 provides a close up view of the levered wheel mechanism used to move the coop.

In one embodiment the coop is specially designed to protect the poultry or hens from pathogens and predators. Some predators for example fox or raccoon or the like, may dig ground under the periphery of the poultry coop and enter into the coop. To prevent this, the coop of the present invention is a provided with a three or 3 inch strip of steel mesh mounted on a wooden frame. The coop weighs about 260 lbs.

The roofed-in section is provided with an adjoining nesting box section, a feeder and one or more perches for the poultry or hens to stand on at night. The feeder is hung from the roof. The nesting box section is accessible from outside and roofed-in section is made from heavy gauged plastic or marine ply. To provide the poultry a clean environment and protect from pathogens developing inside the coop, it is always preferable to move the coop. The coop of the present invention is having distinct advantage over other coops of the past as it can be pulled or dragged by a single person alone. The wheels are provided on the rear part of the roofed-in section on each side. The wheels work on levered when mechanism.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I claim:

1. A predator proof movable poultry coop, comprising:
an outdoor caged over section;
an adjoining roofed-in section with an adjoining nesting box section;
one or more retractable wheels.

2. The predator proof movable poultry coop according to claim 1, wherein the outdoor caged over section and the adjoining roofed-in section with an adjoining nesting box section are mounted on a timber frame.

3. The predator proof movable poultry coop according to claim 1, wherein the adjoining roofed-in section comprises a feeder and one or more perches.

4. The predator proof movable poultry coop according to claim 3, wherein the feeder is suspended from inside the roof of the adjoining roofed-in section.

5. The predator proof movable poultry coop according to claim 3, wherein hens stand on one or more perches at night.

6. The predator proof movable poultry coop according to claim 1, wherein the nesting box section is accessible from outside.

7. The predator proof movable poultry coop according to claim 1, one or more retractable wheels are connected on each side of rear part of the adjoining roofed-in section.

8. The predator proof movable poultry coop according to claim 8, wherein one or more retractable wheels work on levered wheel mechanism.

9. The predator proof movable poultry coop according to claim 1, wherein the outer caged section is made of a strip of steel mesh running around inner periphery and mounted on a wooden frame at ground level.

10. The predator proof movable poultry coop according to claim 1, wherein the adjoining roofed-in section is made of heavy gauged plastic sheeting or marine ply.

11. The predator proof movable poultry coop according to claim 1, wherein the coop is designed to be pulled by a single person.

12. The predator proof movable poultry coop according to claim 11, wherein the coop is can be regularly moved onto fresh ground.

13. The predator proof movable poultry coop according to claim 1, wherein the coop is designed to protect hens in a predator infested environment including pathogens.
